(19) United States
(12) Patent Application Publication
(10) Pub. No.: US 2025/0286687 A1
(43) Pub. Date: Sep. 11, 2025

(54) COOPERATIVE RANDOM ACCESS FOR CELL-FREE NETWORKS

(71) Applicant: HUAWEI TECHNOLOGIES CO., LTD., Shenzhen (CN)

(72) Inventors: Alexis DECURNINGE, Boulogne Billancourt (FR); Maxime GUILLAUD, Boulogne Billancourt (FR); Sofiane KHARBECH, Boulogne Billancourt (FR)

(73) Assignee: HUAWEI TECHNOLOGIES CO., LTD., Shenzhen (CN)

(21) Appl. No.: 19/209,924

(22) Filed: May 16, 2025

Related U.S. Application Data
(63) Continuation of application No. PCT/EP2022/082402, filed on Nov. 18, 2022.

(51) Int. Cl. H04L 5/00; H04W 48/16

(52) U.S. Cl. CPC H04L 5/0055; H04L 5/0048; H04W 48/16

(57) ABSTRACT

This disclosure relates to cell-free network. A network device is provided, which maintains a first dataset indicating neighboring network devices, and second datasets each indicating one or more user IDs. One second dataset is associated with the network device, and each other second dataset is associated with one neighboring network device of the first dataset. The network device receives signals from user devices, wherein each signal comprises a respective user ID and a respective payload of one user device. The network device separates one or more signals to obtain the respective user IDs and payloads, and sends first exchange information to each neighboring network device that is in the first dataset and is associated with a second dataset including at least one obtained respective user ID. The sent first exchange information comprises at least one obtained respective user ID and respective payload.

### CROSS-REFERENCE TO RELATED APPLICATIONS

This application is a continuation of International Application No. PCT/EP2022/082402, filed on Nov. 18, 2022, the disclosure of which is hereby incorporated by reference in its entirety.

### TECHNICAL FIELD

The present disclosure relates to communication networks and systems, specifically cell-free communication networks. The disclosure provides a network device for a cell-free wireless communication network, and a method for operating the network device.

### BACKGROUND

Cell-free networks are composed of multiple network devices, e.g., access points (APs), which serve multiple user devices (e.g., UEs), wherein the user devices are not attached to a particular network device.

Conventional cell-free networks operate based on the assumption of a multiple-access scenario, wherein active user devices are known, and wherein pilot sequences are assigned to these active user devices in a coordinated manner (i.e., conventional cell-free networks are not grant-free). Uplink (UL) communications of the user devices are then divided into two steps: a first step of channel estimation, wherein the pilot sequences are transmitted by the user devices; and a second step of communication, wherein the user devices transmit their messages. Random-access schemes in the conventional cell-free networks further perform a step of activity detection based on preamble sequences.

Notably, “grant-free” means that in the network, one or more transmitting devices (UEs for the UL) transmit messages to one or more receiving devices (APs for the UL) without any prior resource request or grant. Further, “random access” means that a random number of transmitting devices in the network are active at the same time. Grant-free and random access communications are typical for massive internet of things (IoT) scenarios.

An issue is, that for communication networks and systems, in which activity detection and decoding are to be performed jointly (cooperatively) by network devices, the above-described activity detection methods of the conventional cell-free networks are not applicable. Thus, new solutions are needed for cooperative random access for cell-free networks.

### SUMMARY

In view of the above, the present disclosure is related to cell-free networks and random access. An objective of this disclosure is to enable cooperative random access for a cell-free (wireless) network. A particular objective is to enable cooperative decoding of signals transmitted by multiple user devices to multiple network devices in the cell-free network.

These and other objectives are achieved by this disclosure as described in the enclosed independent claims. Advantageous implementations are further defined in the dependent claims.

A first aspect of this disclosure provides a network device for a cell-free wireless communication network, the network device being configured to: maintain a first dataset indicating one or more neighboring network devices; maintain a plurality of second datasets each indicating one or more user IDs, wherein one second dataset of the plurality of second datasets is associated with the network device, and each other second dataset of the plurality of second datasets is associated with one of the one or more neighboring network devices in the first dataset; receive a plurality of signals from a plurality of user devices in a first interval, wherein each signal comprises a respective user ID of one of the user devices and a respective payload of one of the user devices; separate, in the first interval, one or more signals of the plurality of signals to obtain the respective user IDs and the respective payloads of the one or more signals; and send, in the first interval, first exchange information to each neighboring network device, which is in the first dataset and is associated with a second dataset that includes at least one of the obtained respective user IDs; wherein the sent first exchange information comprises at least one of the obtained respective user IDs and at least one of the obtained respective payloads.

By maintaining the first dataset and second datasets, and by sending the first exchange message to the neighboring network devices (which may also maintain a first dataset and second datasets), the network device of the first aspect supports cooperative separation (decoding) of the plurality of signals transmitted by the multiple user devices to the network device and the neighboring network devices. Thus, the network device of the first aspect supports cooperative random access in a cell-free network, for instance, a cell-free wireless/mobile network.

In an implementation form of the first aspect, if a particular user ID of the obtained respective user IDs is not in the second dataset associated with the network device, the network device is configured to send, in the first interval, second exchange information to each neighboring network device, which is in the first dataset and is associated with a second dataset that does not include the particular user ID; wherein the second exchange information comprises the particular user ID but not the respective payload corresponding to the particular user ID.

This allows decreasing the signaling overhead for the cooperative random access method.

In an implementation form of the first aspect, the network device is further configured to: receive, in the first interval, first exchange information from a neighboring network device, wherein the received first exchange information comprises at least one of the respective user IDs and at least one of the respective payloads of the plurality of signals; and further separate, in the first interval, one or more of the plurality of signals based on the separated signals and the respective payloads in the received first exchange information.

Accordingly, the network device may exchange first exchange message with the neighboring network devices to enable the cooperative separation (decoding) of the plurality of signals transmitted by the multiple users.

In an implementation form of the first aspect, the network device is further configured to send, in a second interval, the second exchange information to each neighboring network device in the first dataset.

In an implementation form of the first aspect, the network device is further configured to perform the separation of the one or more signals of the plurality of signals, in the first interval, without prior knowledge of the respective user IDs and the respective payloads of the one or more signals.

Thus, random access in a cell-free network is supported.

In an implementation form of the first aspect, the first exchange information received from the neighboring network device comprises one or more respective user IDs and one or more respective payloads that are different than in the sent first exchange information.

In an implementation form of the first aspect, in the further separation of the one or more signals of the plurality of signals, in the first interval, the network device is configured to perform interference cancellation.

Thus, an improved separation of the plurality of signals is achieved.

In an implementation form of the first aspect, the network device is further configured to update the second dataset associated with the network device based on the one or more separated signals and the one or more further separated signals, and/or update one or more second datasets associated with one or more neighboring network devices based on first exchange information received from the one or more neighboring network devices.

Accordingly, the network device of the first aspect (and in a similar manner this may also be done by the neighboring network devices), maintains up-to-date information on the connections in the cell-free network.

In an implementation form of the first aspect, the network device is configured to update the second dataset associated with the network device and/or the one or more second datasets associated with the one or more neighboring network devices by at least one of: adding one or more user IDs to the second dataset associated with the network device; and adding one or more user IDs to one or more second datasets associated with one or more neighboring network devices; and removing one or more user IDs from the second dataset associated with the network device; and removing one or more user IDs from the one or more second datasets associated with the one or more neighboring network devices.

In an implementation form of the first aspect, the network device is further configured to associate a timestamp with any user ID added to a second dataset.

In an implementation form of the first aspect, the network device is further configured to remove any user ID from a second dataset, if a timestamp associated with the user ID is older than a threshold.

In an implementation form of the first aspect, the network device is further configured to adjust the threshold based on at least one of a network condition and an upper layer configuration.

In an implementation form of the first aspect, the network device is further configured to: add a user ID of a separated signal or a further separated signal to the second dataset of the network device, if the user ID of the separated signal is not already in the second dataset of the network device; and/or add a user ID in first exchange information received from a neighboring network device to the second dataset of that neighboring network device, if the user ID in the first exchange information is not already in the second dataset of that neighboring network device.

A second aspect of this disclosure provides a method for a network device of a cell-free wireless communication network, the method comprising: maintaining a first dataset indicating one or more neighboring network devices; maintaining a plurality of second datasets each indicating one or more user IDs, wherein one second dataset of the plurality of second datasets is associated with the network device, and each other second dataset of the plurality of second datasets is associated with one of the one or more neighboring network devices in the first dataset; receiving a plurality of signals from a plurality of user devices in a first interval, wherein each signal comprises a respective user ID of one of the user devices and a respective payload of one of the user devices; separating, in the first interval, one or more signals of the plurality of signals to obtain the respective user IDs and the respective payloads of the one or more signals; and sending, in the first interval, first exchange information to each neighboring network device, which is in the first dataset and is associated with a second dataset that includes at least one of the obtained respective user IDs; wherein the first exchange information comprises at least one of the obtained respective user IDs and at least one of the obtained respective payloads.

The method of the second aspect may have implementation forms, which correspond to the implementation forms of the network device of the first aspect. The method of the second aspect and its possible implementation forms achieve the same advantages as described above for the network device of the first aspect and its respective implementation forms.

A third aspect of this disclosure provides a computer program comprising instructions which, when the program is executed by a computer, cause the computer to perform the method according to the second aspect and its possible implementation forms.

A fourth aspect of this disclosure provides a non-transitory storage medium storing executable program code which, when executed by a processor, causes the method according to the second aspect and its possible implementation forms to be performed.

According to the above aspects and implementation forms, this disclosure addresses the cooperative separation of signals transmitted by multiple user devices (e.g., multiple UEs) to multiple network devices (e.g., multiple APs) in a cell-free wireless network.

The disclosure proposes the first dataset, the contents of which may be represented by a connectivity graph indicating the knowledge of the connections between the user devices and the network devices. Each network device may maintain such a first dataset. The first datasets may be employed to exchange signals (first and second exchange information) between the network devices sharing the same user devices. These exchange signals may then be used by the network devices to perform interference cancelation, thus improving the decoding performance. The way to build up and use the first datasets in a distributed manner is explained in this disclosure. In particular, the knowledge of the first dataset at each network device may be reduced to the knowledge of the second datasets. The content of the second datasets which may be represented by a neighboring graph including first and second order neighboring network devices of a respective network device.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

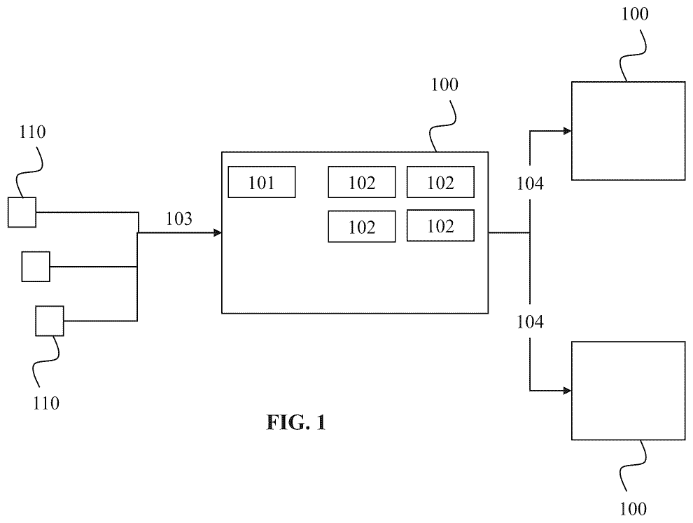

The above-described aspects and implementation forms will be explained in the following description of specific embodiments in relation to the enclosed drawings, in which FIG. 1 shows a network device for a cell-free network, according to this

### DISCLOSURE

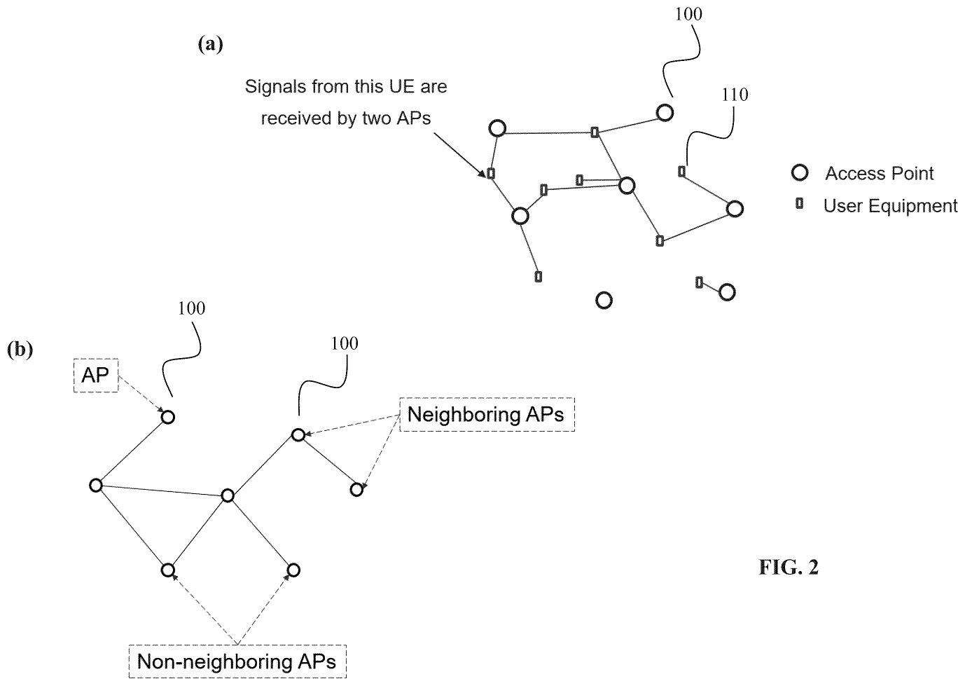

FIG. 2 shows (a) an exemplary connectivity graph, and (b) an exemplary neighboring graph.

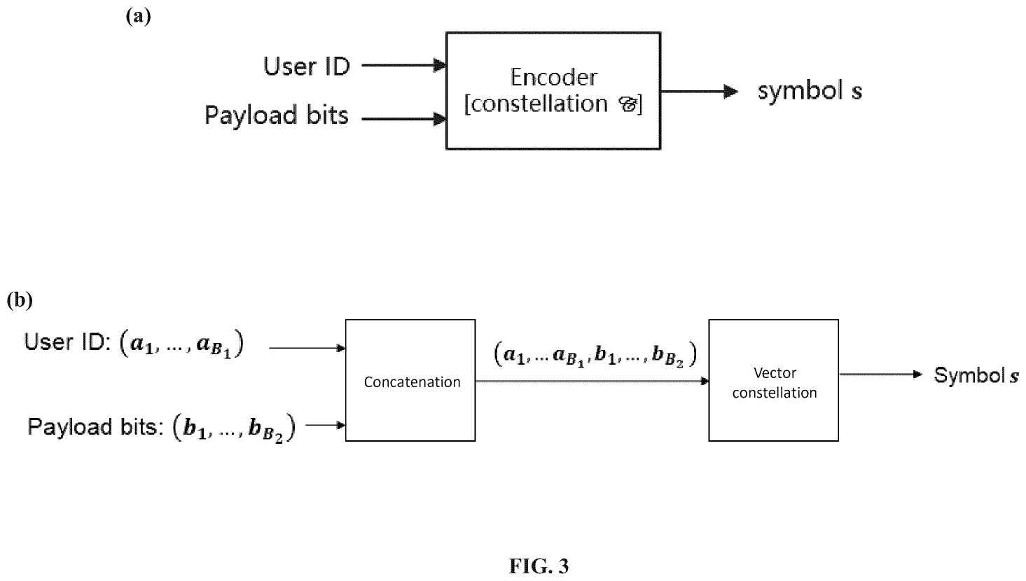

FIG. 3 illustrates (a) information encoding at a user device, and (b) an example of an encoder of a user device.

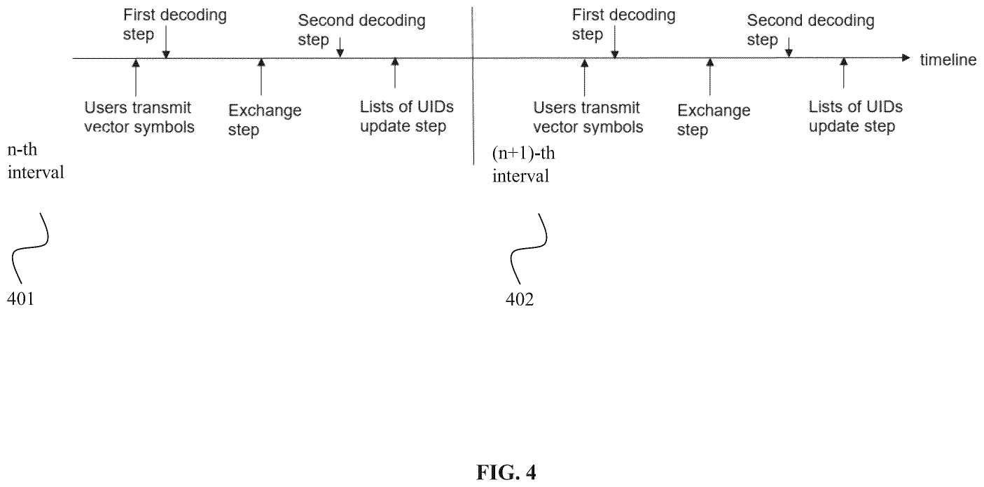

FIG. 4 shows a decoding timeline for two consecutive intervals, wherein the decoding is performed by a network device according to this disclosure.

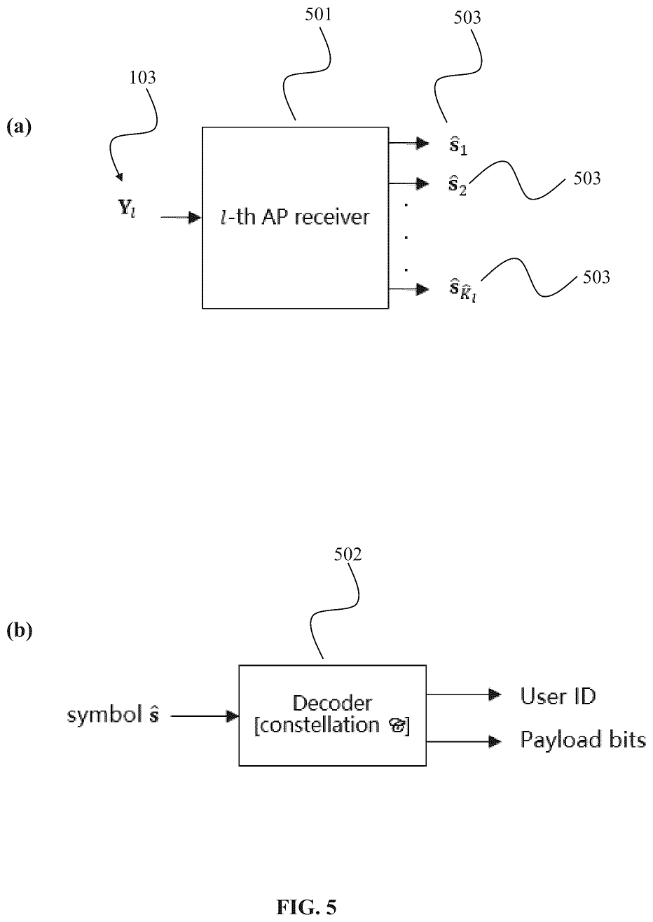

FIG. 5 shows (a) a separation of signals of multiple user devices in a first decoding step, and (b) an example for information decoding at a network device.

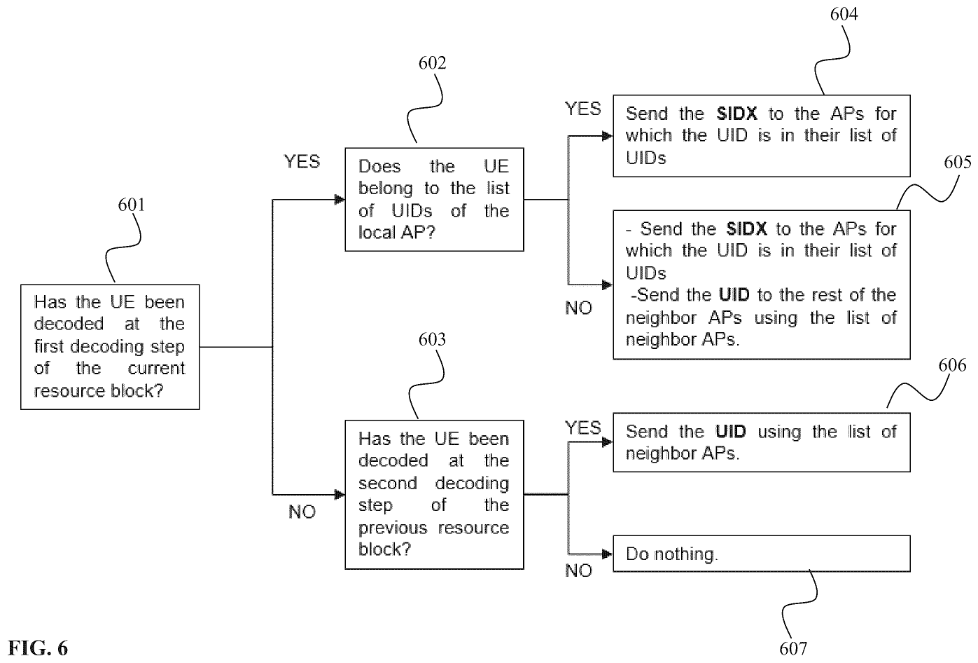

FIG. 6 shows an exemplary scheme of exchanging information for each decoded user device between neighboring network devices.

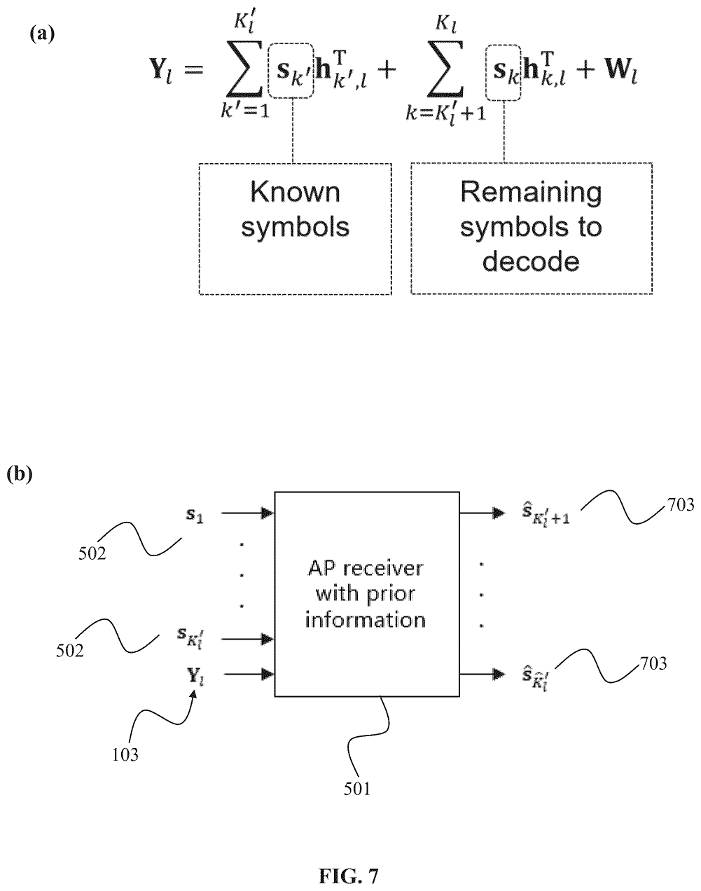

FIG. 7 shows a further separation of signals of multiple user devices in a second decoding step.

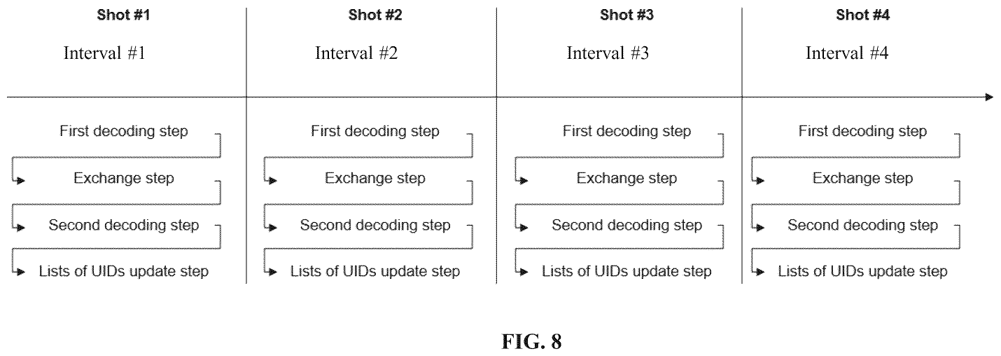

FIG. 8 shows an illustrative example of a decoding scheme proposed by this disclosure with four intervals.

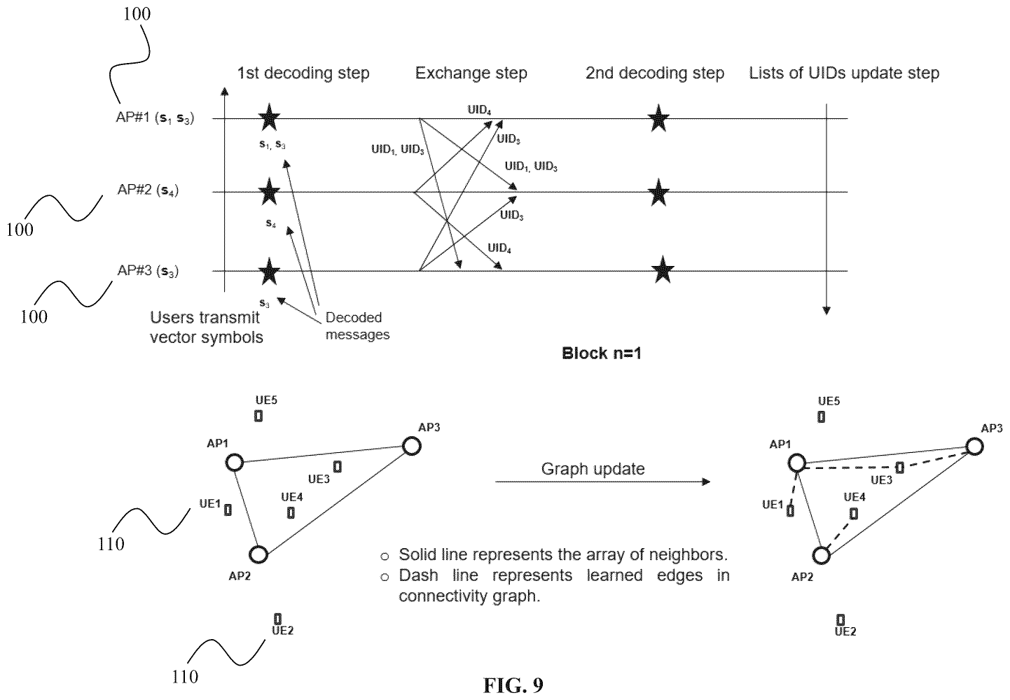

FIG. 9 shows a first interval of the example.

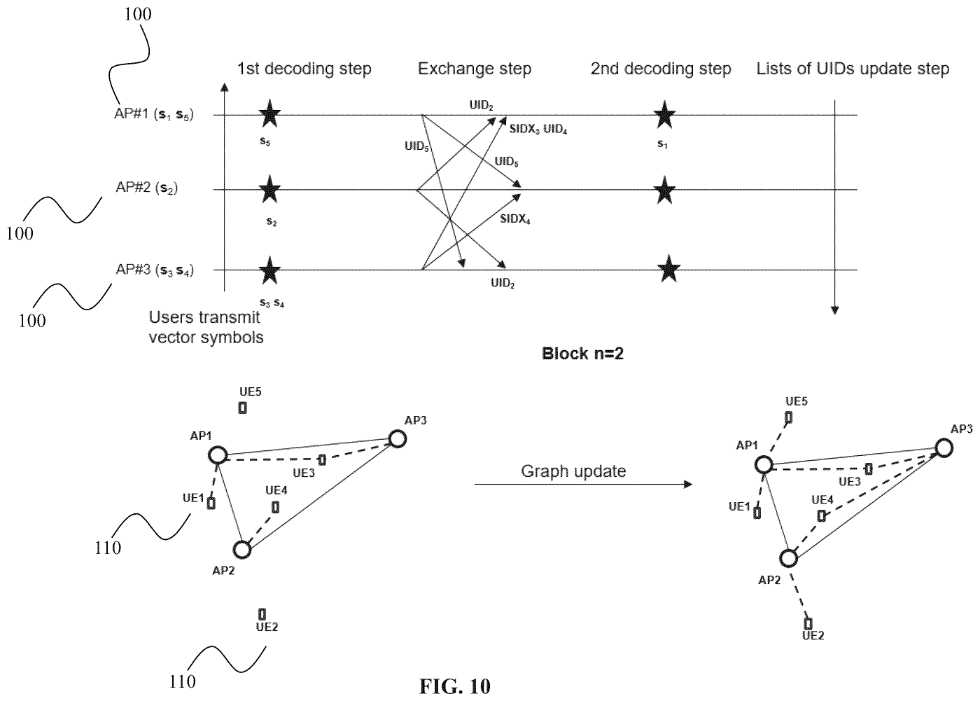

FIG. 10 shows a second interval of the example.

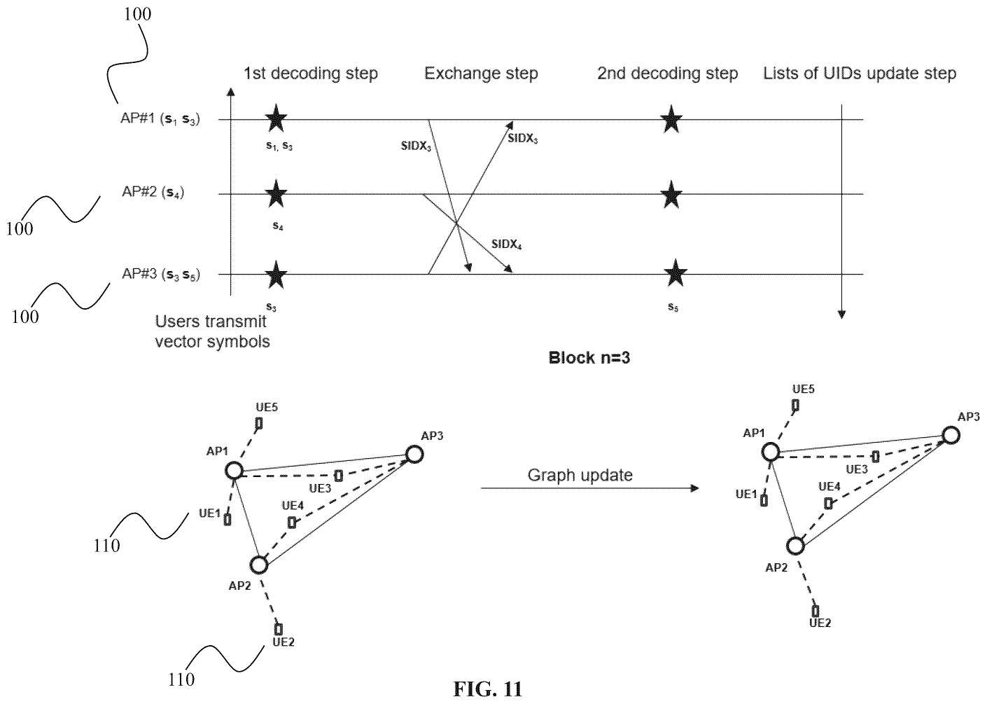

FIG. 11 shows a third interval of the example.

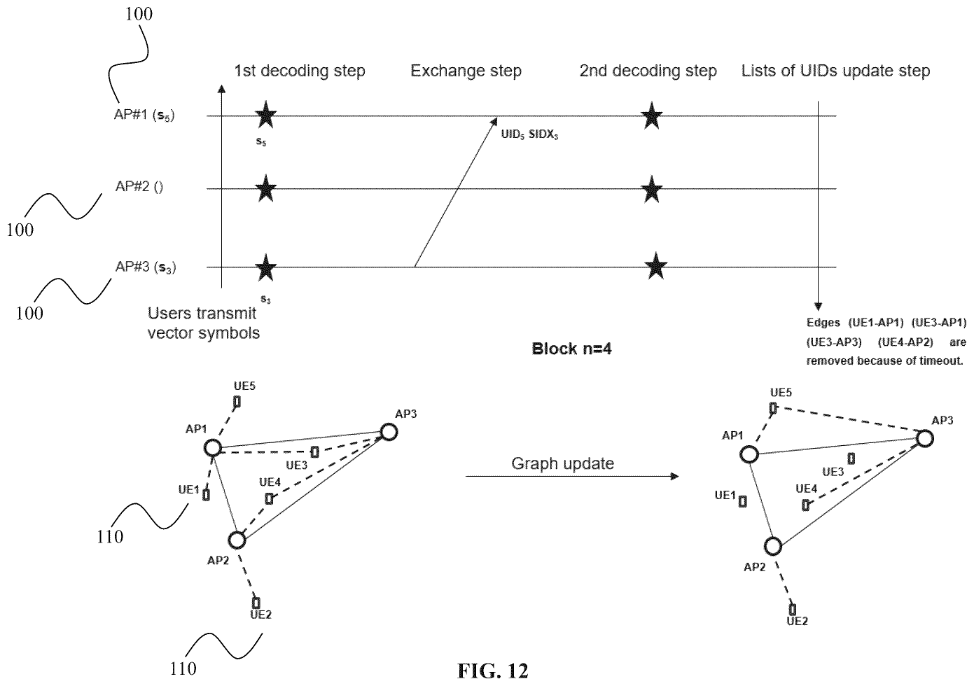

FIG. 12 shows a fourth interval of the example.

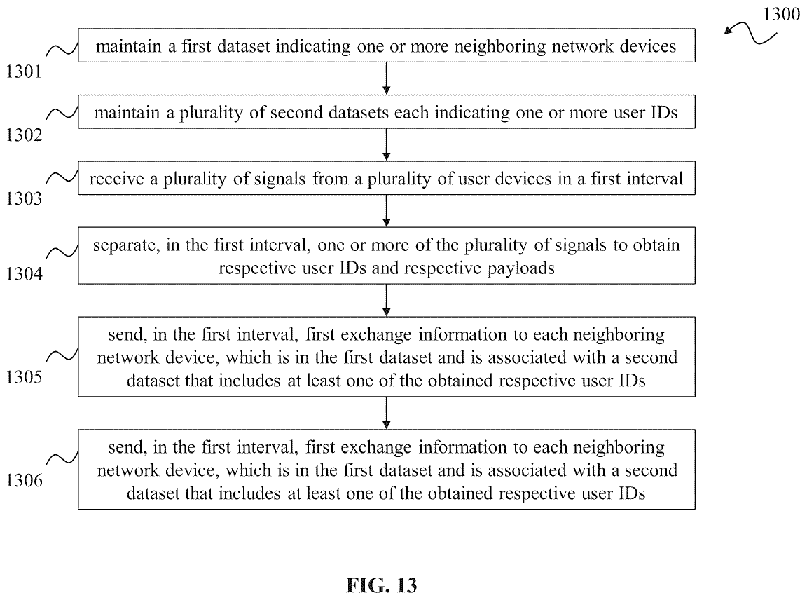

FIG. 13 shows a method for a network device of a cell-free network, according to this disclosure.

### DETAILED DESCRIPTION OF EMBODIMENTS

FIG. 1 shows a network device 100 for a cell-free wireless communication network. The communication network may be a mobile communication network. For instance, the mobile communication network may be a 5^{th} generation (5G), new radio (NR), or other next generation mobile network. The network device may be an AP, or a base station (BS), or a gNodeB, or another type of network access device.

The network device 100 is configured to maintain a first dataset 101, which indicates one or more neighboring network devices 100 of the network device 100. The neighboring network devices 100 could be first-order neighboring network devices 100 of the network device 100, or second-order neighboring network devices 100. Notably, each neighboring network device 100 may be configured like the discussed network device 100.

The network device 100 is also configured to maintain a plurality of second datasets 102. Each second dataset 102 indicates one or more user IDs. One of the second datasets 102 is associated with the network device 100, and each other one of the second datasets 102 is associated with one of the one or more neighboring network devices 100 that are indicated in the first dataset 101.

The network device 100 is further configured to receive a plurality of signals 103 from a plurality of user devices 110 in a first interval. Each user device 110 may be a UE or terminal device. Each signal of the plurality of signals 103 comprises a respective user identification (ID) of one of the user devices 110 and comprises a respective payload (message) of one of the user devices 110. Notably, the plurality of signals 103 from the user devices 110 may also be received by the one or more neighboring network devices 100. That is, a neighboring network device 100 of the network device 100 may be one that can potentially receive and decode a user device signal that the network device 100 can also receive and decode.

The network device 100 is configured to separate, in the first interval, one or more signals of the plurality of signals 103, in order to obtain the respective user IDs and the respective payloads of these one or more signals. That is, for each separated signal, the network device 100 may obtain the respective user ID and the respective payload.

Then, the network device 100 is configured to send, in the first interval, first exchange information 104 to each neighboring network device 100, which is indicated in the first dataset 101 and which is associated with a second dataset 102 that includes at least one of the obtained respective user IDs. The sent first exchange information 104 comprises at least one of the obtained respective user IDs and at least one of the obtained respective payloads.

Moreover, the network device 100 may receive, also in the first interval, similar first exchange information 104 from at least one of the neighboring network devices 100. The received first exchange information 104 comprises at least one of the respective user IDs and at least one of the respective payloads of the plurality of signals 103. The first exchange information 104 received from the at least one neighboring network device 100 may comprise one or more respective user IDs and one or more respective payloads that are different than those in the sent first exchange information 104. Accordingly, the network device 100 and its neighboring network devices 100 may exchange first exchange information 104.

The network device 100 may additionally be configured to further separate, in the first interval, one or more of the plurality of signals 103 based on the (previously) separated signals and based on the respective payloads included in the received first exchange information 104. In this sense, the first exchange information 104 is used for further separating the signals, and this may be done at each network device 100. The network device 100 and the neighboring network devices 100 may thus collaborate to separate the signals.

Notably, the separating and the further separating of the signals of the plurality of signals 103 may be considered decoding steps. Thus, the network device 100 may participate in cooperative decoding of the signals transmitted by the multiple user devices (to the network device 100 and the neighboring network devices 100), specifically in a cell-free wireless network.

Each network device 100 may comprise a processor or processing circuitry (not shown) configured to perform, conduct or initiate the various operations of the network device 100 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Each network device 100 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the network device 100 to be performed. In one embodiment, the processing circuitry comprises one or more processors and a non-transitory memory connected to the one or more processors. The non-transitory memory may carry executable program code which, when executed by the one or more processors, causes the network device 100 to perform, conduct or initiate the operations or methods described herein.

Further considerations and details of the above-discussed solutions of this disclosure are described in the following.

Within an area of interest, the communication network or system may comprise a set of network devices 100 (e.g., APs), including the network device 100 and its neighboring network devices 100 discussed above, and optionally further network devices, and may comprise a set of user devices 110 (e.g., UEs). For representing such a communication network or system, the first dataset 101 and a plurality of second datasets 102 may be used, for instance, individually maintained at each network device 100. The content of these datasets 101, 102 may be represented by two graphs, a connectivity graph as shown in FIG. 2(a), and a neighboring graph as shown in FIG. 2(b). These graphs may particularly illustrate the contents of all datasets 101, 102.

The connectivity graph may have two sorts of nodes, the network devices 100 (for example APs, as used in the figures) and the user devices 110 (for example UEs, as used in the figures). It is a bipartite graph to describe the connectivity between the user devices 110 and the network devices 100. This means that a network device node can only be connected to one or more user device nodes of the graph. Similarly, a user device node can only be connected to one or more network device nodes of the graph. An edge in the connectivity graph between a network device 100 and a user device 110 indicates that a message transmitted by the user device 110 has been decoded by the network device 100 in the recent past.

The neighboring graph has only one kind of node, namely network devices 100. This graph, i.e., the data it represents, may be known a priori by the network devices 100. Two network devices 100 may be connected in the neighboring graph, if they can potentially decode a common user device message. The following example criteria can be used to determine, if two network devices 100 are connected in the neighboring graph: (i) propagation characteristics ensure sufficient receive signal strength at both network devices 100; (ii) geometrical consideration of the geographical scene such as the distance between the two network devices 100 and a user device 110 is below some threshold; (c) the distance between the two network devices 100 is below some threshold (d) backhaul network architecture characteristics.

Notably, the illustration of the neighboring graph is an overview of the set of network devices 100. In contrast, each network device 100 may have only partial knowledge of the graph in the sense that each network device 100 may know only its neighboring network devices 100 (that is, individual second datasets may be maintained by the network devices 100).

The two graphs in FIG. 2 are for illustrative purposes only. The knowledge of these graphs may be acquired through two objects that each network device 100 stores and maintains locally: (i) a list of neighboring network devices 100 (an example of the first dataset 101); (ii) for each network device 100 in the list of neighboring network devices 100 and the local network device 100 itself, a list of user devices 110 connected to the network device 100 (an example of the second datasets 102), wherein any list can be empty if the considered network device 100 has no connected user device 110. The disclosure also refers to these lists as lists of user IDs or lists of UIDs. Each element of the lists of user IDs may be tagged by a timestamp. In this disclosure, UL communication is considered as an example, where user

devices 110 and network devices 100 are the transmitters and receivers, respectively. This UL communication happens during multiple time intervals. During each interval, a subset of the user devices 110 (denoted as active user devices 110) may transmit a payload (message) consisting of a sequence of bits. The fact that a user device 110 is active or inactive is not known by the network devices 100. Since a cell-free network is configured in this disclosure, each user device 110 is not attached to a particular network device 100, and its payload can be decoded by any network device 100.

Taking the example of a single-input multiple-output block fading multiple access channel (SIMO-BF-MAC), one can assume that, for each interval, the user devices 110 and network devices 100 are synchronized in time, so that the signal received by a network device 100 is the sum of the contribution of each user device 110. With these assumptions, at a particular network device l (wherein the index l may refer to the identifier of the network device 100) of NI receiving antennas, during an interval of length T, the baseband received signal Yₗ∈ [symbol] ^{T×N}^{ₗ} from Kₗ active user devices 110 can be expressed as

$${Y}_{l} = {\sum }_{k = 1}^{{K}_{l}} {s}_{k} {h}_{k , l}^{T} + {W}_{l}$$

where sₖ∈ [symbol] ^{T} is the transmitted signal of the user device k, h_{k,l}∈ [symbol] ^{N}^{ₗ} is the channel vector between the user device k and the network device l, and Wₗ [symbol] ^{T×N}^{ₗ} is an additive noise term. The signal Yₗ may accordingly be the plurality of signals 103 referred to above.

Each user device 110 may encode its signal to a vector symbol sₖ chosen in the common vector constellation C. The vector constellation can be characterized as a set of 2^{B} complex vectors

C={c₁, . . . ,c₂_{^{B}}}.

Note that this constellation may be common to all user devices 110, and may be known by all the user devices 110 and the network devices 100. The signal transmitted in each interval may be composed of the user ID and payload bits. FIG. 3(a) illustrates an example of a transmission scheme that may be used in this disclosure

An example of the encoder is shown in FIG. 3(b), and may be configured as follows. The user ID and the payload bits may be concatenated, and this concatenated sequence of bits may be translated into an integer index corresponding to an element of the constellation C with 2^{B}^{₁}^{+B}^{₂} elements (hence, B=B₁+B₂).

The network device 100 proposed by this disclosure processes the signals sent by user devices 110 following four steps that are now detailed below: (i) a first decoding step, (ii) an exchange step, (iii) a second decoding step, and (iv) an update step. FIG. 4 shows the decoding steps for two successive intervals, namely the first interval 401 and the second interval 402.

The steps (i), (iii), and (iv) may be performed independently at each network device 100, e.g., based on the current knowledge of the local lists of UIDs, i.e., the examples of the second datasets 102 maintained by that network device 100. These local lists of UIDs may evolve over time during each step (iv). The processing described in this disclosure is distributed, since no central network device or node with full knowledge of the transmitted signals is involved in the processing, nor is a full connectivity graph of the network used.

In the first decoding step, each network device 100 separates received signals 503 of the plurality of signals 103 of the plurality of user devices 110 without prior knowledge about either the user ID or payload. FIG. 5(a) depicts the input and output for this step, which may be done by a receiver 501 of the network device 100, and where ŝₖ∈ [symbol] ^{T} is a recovered signal 503 of the user device k and \hat{K}ₗ denotes the number of active user devices decoded by the network device l.

The user ID and the payload of each separated signal 503 can be recovered through a constellation demapper 502 as shown in FIG. 5(b).

The signal separation step is in fact a step of un-mixing the transmitted plurality of signals 103. For example, for the SIMO-BF-MAC channel, this step can be implemented by solving the following optimization problem (wherein \hat{K}ₗ=Kₗ).

$${{min}_{{s}_{l} , … , {s}_{{K}_{l}} ∈ C}}_{{h}_{l} , … , {h}_{{K}_{l}} ∈ {C}^{{N}_{l}}} ‖ {Y}_{l} - {\sum }_{k = 1}^{{K}_{l}} {s}_{k} {h}_{k , l}^{T} ‖$$

In the exchange step, the network devices 100 can then exchange two types of information: (i) the user ID (denoted as UID) of the separated user device signals 503 (second exchange information); or (ii) the index of the transmitted signal s in the constellation C (denoted as SIDX) of a separated user signal 504, if the related user device 110 has been decoded at the first decoding step of the current interval 401. The SIDX contains both the user ID and its payload and may be the first exchange information 104 described above.

The exchanged information may then be employed by the neighbor network devices 100 to improve their performance in the next decoding step or for the next interval 402. Note that the exchange step may rely on the results of the second decoding step of the previous interval, and the first decoding step of the current interval 401.

During the exchange step, a network device 100 transmits either UID or SIDX about their decoded user devices 110 to its neighbor network devices 100 according to the flow chart shown in FIG. 6.

In particular, at block 601, the network device 100 determines, whether a user device 110 has been decoded at the first decoding step of the current interval (here referred to as “resource block”). If yes, then in block 602 the network device 100 determines whether the user device 110 belongs to the second dataset 102 maintained at the network device 100, i.e., whether a user ID of the user device 110 is in said second dataset. If yes, then at block 604, the network device sends the first exchange information 104 to the neighboring network devices 100, which are in the first dataset 101 and are associated with a second dataset 102 that includes the user ID. If no, then at block 605 the network device 100 sends the first exchange information 104 to the neighboring network devices 100, which are in the first dataset 101 and are associated with a second dataset 102 that includes the user ID, and sends the second exchange information to the rest of the neighboring network devices 100 in the first dataset 101.

If at block 601 the answer is no, then at block 603 the network device 100 determines whether the user device 110 has been decoded at the second decoding step of the previous interval. If yes, then at block 606 the network device sends the second exchange information to all neighboring network devices 100 in the first dataset 101. If yes, then the network device 100 does nothing.

In the second decoding step, the network device 100 performs a second separation of the received plurality of signals 103, while considering the previously decoded signals 503 (during the first decoding step) and the received SIDXs (first exchange information 104) of decoded user devices 110 on neighboring network devices 100 (received in the exchange step). At a given network device 100, let K′ₗ<Kₗ be the total number of successfully decoded user signals 503 coming from both the first decoding and exchanging step. For example, for the SIMO-BF-MAC, the received signal Yₗ may be reformulated as shown in FIG. 7(a).

FIG. 7(b) notes as \hat{K}′ₗ the number of active user devices 110 decoded, i.e., their signals 703 separated in the further separating, by the network device l by the end of the second decoding step.

An interference Cancellation (SIC) receiver 501 is an example of a decoder that can be applied here, since it uses the previously decoded signals to decode the unknown ones. In the case of the SIMO-BF-MAC, it can be implemented by solving the following optimization problem.

$${{min}_{{s}_{{K}_{l}^{′} + 1} , … , {s}_{{K}_{l}} ∈ C}}_{{h}_{l} , … , {h}_{{K}_{l}} ∈ {C}^{{N}_{l}}} ‖ {Y}_{l} - {\sum }_{{k}^{′} = 1}^{{K}_{l}^{′}} {s}_{{k}^{′}} {h}_{{k}^{′} , l}^{T} + {\sum }_{k = {K}_{l}^{′} + 1}^{{K}_{l}} {s}_{k} {h}_{k , l}^{T} ‖$$

Note that this kind of receiver (interference cancellation) is employed in many detection schemes in the context of random access with joint activity detection and payload decoding.

In the update set, the lists of user IDs (the second datasets 102) are updated based on the results of both first decoding step of the current interval 401, and the second decoding of the previous interval.

In this update step, the lists of user IDs may be updated by keeping useful connections (to avoid oversized lists) and adding new ones following newly connected user devices 110. The updating may be done based on the locally separated signals 503, 703 and information received from neighboring network devices 100. The connectivity graph may thus be updated in a distributed way, since each network device 100 performs the update process of its own subgraph (i.e., local update of the second datasets 102). During this step, a network device 100 can: (i) add a user device 110 to the “local” network device lists of UIDs (second dataset 102 associated with the network device 100) for a user device 110 whose signal 503, 703 has been decoded locally, and tag the edge with a timestamp; (ii) add a user device 110 to a neighbor network device list of UIDs (second dataset 102 associated with a neighboring network device 100), when the information has been transmitted during the exchange step, and tag the edge with a timestamp; (iii) prune elements of the lists of UIDs, for which the associated timestamp is older than a threshold (timeout).

The threshold may be set depending on the network conditions and can be updated by the upper layers of the network. For instance, the timeout threshold can be adjusted dynamically to have an optimized connectivity subgraph on each network device 100. This prevents large lists of UIDs (useless entries) or undersized lists (insufficient amount of information to exchange).

In the following illustrative example, three APs as network devices 100 and five UEs as user devices 110 are considered. The example is presented throughout four time intervals (also referred to as four macro time shots). Within each interval, the timeline is represented following the four main steps of the proposed scheme described above. FIG. 8 summarizes the four intervals of the example.

In the first interval (see also FIG. 9), the APs 1, 2, and 3 have successfully separated the following signals (s₁, s₃), (s₄), and (s₃), respectively. After the exchange step, no remaining signals are to be separated in the second decoding step, and the connectivity graph is updated accordingly; only new edges are added herein, (AP1-UE1), (AP1-UE3), (AP3-UE3), and (AP2-UE4).

In the second interval (see FIG. 10), the APs 1, 2, and 3 have successfully separated the following signals (s₁), (s₂), and (s₃, s₄), respectively. After the exchange step, no remaining signals are to be separated in the second decoding step for APs 2 and 3, but at AP1, the set (s₁) still needs to be separated at the second decoding step. Then, the connectivity graph is updated accordingly; only new edges are added herein, (AP1-UE5), (AP2-UE2), and (AP3-UE4).

In the third interval (see FIG. 11), the APs 1, 2, and 3 have successfully separated the following sets (s₁, s₃), (s₄), and (s₃), respectively. After the exchange step, no remaining signals are to be separated in the second decoding step for the APs 1 and 2, but at the AP 3, the set (s₅) still needs to be separated in the second decoding step. Herein, no new connection needs to be added to the connectivity graph.

In the fourth interval (see FIG. 12), the APs 1 and 3 have successfully separated the following sets (s₅) and (s₃), respectively. Note here that the AP 3 transmits the information about the ID of UE 5 since it has been decoded during the second decoding step of the previous time interval. After the exchange step, no remaining signals are to be separated in the second decoding step. The connectivity graph is updated accordingly; the connection (AP3-UE5) is added accordingly and connections (AP1-UE1), (AP1-UE3), and (AP3-UE3) are removed because of timeout reach.

FIG. 13 shows a method 1300 for a network device 100 of a cell-free wireless communication network. The method 1300 may be performed by any network device 100 described above.

The method 1300 comprises a step 1301 of maintaining a first dataset 101 indicating one or more neighboring network devices 100, and a step 1302 of maintaining a plurality of second datasets 102 each indicating one or more user IDs. One second dataset 102 of the plurality of second datasets is associated with the network device 100, and each other second dataset 102 of the plurality of second datasets is associated with one of the one or more neighboring network devices 100 in the first dataset 101.

The method 1300 further comprises a step 1303 of receiving a plurality of signals 103 from a plurality of user devices 110 in a first interval 401, wherein each signal 503, 703 comprises a respective user ID of one of the user devices 110 and a respective payload of one of the user devices 110.

The method 1300 further comprises a step 1304 (corresponding to the first decoding step described above) of separating, in the first interval 401, one or more signals 503 of the plurality of signals 103 to obtain the respective user IDs and the respective payloads of the one or more signals 503.

The method 1300 further comprises a step 1305 (corresponding to the exchange step described above) sending, in the first interval 401, first exchange information 104 to each neighboring network device 100, which is in the first dataset 101 and is associated with a second dataset 102 that includes at least one of the obtained respective user IDs. The first exchange information 104 comprises at least one of the obtained respective user IDs and at least one of the obtained respective payloads. In the step 1305, also first exchange information 104 from a neighboring network device 100 may be received, wherein the received first exchange information 104 comprises at least one of the respective user IDs and at least one of the respective payloads of the plurality of signals 103.

The method 1300 may further comprise a step (corresponding to the second decoding step described above) of further separating, in the first interval 401, one or more signals 703 of the plurality of signals 103 based on the previously separated signals 503 and the respective payloads in the received first exchange information 104.

The method 1300 may further comprise a step (corresponding to the update step described above) of updating the second dataset 102 associated with the network device 100 based on the one or more separated signals 503 and the one or more further separated signals 703, and/or updating one or more second datasets 102 associated with one or more neighboring network devices 100 based on first exchange information 104 received from the one or more neighboring network devices 100.

In summary, this disclosure proposes a cooperation process in the context of random access, which includes structuring and updating datasets 101, 102, which indicate network device to user device connections (e.g., AP-UE connections) at each of a set of network devices 100. This is done to exchange the separated signals 503, 703 between the network devices 100 based on the learned local datasets 102.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A network device (100) for a cell-free wireless communication network, the network device (100) being configured to:
maintain a first dataset (101) indicating one or more neighboring network devices (100);
maintain a plurality of second datasets (102) each indicating one or more user IDs, wherein one second dataset (102) of the plurality of second datasets is associated with the network device (100), and each other second dataset (102) of the plurality of second datasets is associated with one of the one or more neighboring network devices (100) in the first dataset (101);
receive a plurality of signals (103) from a plurality of user devices (110) in a first interval (401), wherein each signal (503, 703) comprises a respective user ID of one of the user devices (110) and a respective payload of one of the user devices (110);
separate, in the first interval (401), one or more signals (503) of the plurality of signals (103) to obtain the respective user IDs and the respective payloads of the one or more signals (503); and
send, in the first interval (401), first exchange information (104) to each neighboring network device (100), which is in the first dataset (101) and is associated with a second dataset (102) that includes at least one of the obtained respective user IDs;
wherein the sent first exchange information (104) comprises at least one of the obtained respective user IDs and at least one of the obtained respective payloads.

2. The network device (100) according to claim 1, wherein, if a particular user ID of the obtained respective user IDs is not in the second dataset (102) associated with the network device (100), the network device (100) is further configured to:
send, in the first interval (401), second exchange information to each neighboring network device (100), which is in the first dataset (101) and is associated with a second dataset (102) that does not include the particular user ID;
wherein the second exchange information comprises the particular user ID but not the respective payload corresponding to the particular user ID.

3. The network device (100) according to claim 1, further configured to:
receive, in the first interval (401), first exchange information (104) from a neighboring network device (100), wherein the received first exchange information (104) comprises at least one of the respective user IDs and at least one of the respective payloads of the plurality of signals (103); and
further separate, in the first interval (401), one or more of the plurality of signals (103) based on the separated signals (503) and the respective payloads in the received first exchange information (104).

4. The network device (100) according to claim 2, further configured to:
send, in a second interval (402), the second exchange information to each neighboring network device (100) in the first dataset (101).

5. The network device (100) according to claim 1, configured to:
perform the separation of the one or more signals (503) of the plurality of signals (103), in the first interval (401), without prior knowledge of the respective user IDs and the respective payloads of the one or more signals (503).

6. The network device (100) according to claim 4, wherein the first exchange information (104) received from the neighboring network device (100) comprises one or more respective user IDs and one or more respective payloads that are different than in the sent first exchange information (104).

7. The network device (100) according to claim 1, wherein in the further separation of the one or more signals (703) of the plurality of signals (103), in the first interval (401), the network device (100) is configured to perform interference cancellation.

8. The network device (100) according to claim 3, further configured to:
update the second dataset (102) associated with the network device (100) based on the one or more separated signals (503) and the one or more further separated signals (703), and/or update one or more second datasets (102) associated with one or more neighboring network devices (100) based on the first exchange information (104) received from the one or more neighboring network devices (100).

9. The network device (100) according to claim 8, configured to update the second dataset (102) associated with the network device (100) and/or the one or more second datasets (102) associated with the one or more neighboring network devices (100) by at least one of:
adding the one or more user IDs to the second dataset (102) associated with the network device (100); and
adding the one or more user IDs to one or more second datasets (102) associated with one or more neighboring network devices (100); and
removing one or more user IDs from the second dataset (102) associated with the network device (100); and
removing one or more user IDs from the one or more second datasets (102) associated with the one or more neighboring network devices (100).

10. The network device (100) according to claim 9, further configured to associate a timestamp with any user ID added to a second dataset (102).

11. The network device (100) according to claim 9, further configured to remove any user ID from the second dataset (102), if a timestamp associated with the user ID is older than a threshold.

12. The network device (100) according to claim 11, further configured to adjust the threshold based on at least one of a network condition and an upper layer configuration.

13. The network device (100) according to claim 9, further configured to:
add a user ID of a separated signal or a further separated signal to the second dataset (102) of the network device (100), if the user ID of the separated signal is not already in the second dataset (102) of the network device (100); and/or
add a user ID in first exchange information (104) received from a neighboring network device (100) to the second dataset (102) of that neighboring network device (100), if the user ID in the sent first exchange information (104) is not already in the second dataset (102) of that neighboring network device (100).

14. A method (1300) for a network device (100) of a cell-free wireless communication network, the method (1300) comprising:
maintaining (1301) a first dataset (101) indicating one or more neighboring network devices (100);
maintaining (1302) a plurality of second datasets (102) each indicating one or more user IDs, wherein one second dataset (102) of the plurality of second datasets is associated with the network device (100), and each other second dataset (102) of the plurality of second datasets is associated with one of the one or more neighboring network devices (100) in the first dataset (101);
receiving (1303) a plurality of signals (103) from a plurality of user devices (110) in a first interval (401), wherein each signal (503, 703) comprises a respective user ID of one of the user devices (110) and a respective payload of one of the user devices (110);
separating (1304), in the first interval (401), one or more signals (503) of the plurality of signals to obtain the respective user IDs and the respective payloads of the one or more signals (103); and
sending (1305), in the first interval (401), first exchange information (104) to each neighboring network device (100), which is in the first dataset (101) and is associated with a second dataset (102) that includes at least one of the obtained respective user IDs;
wherein the first exchange information (104) comprises at least one of the obtained respective user IDs and at least one of the obtained respective payloads.

15. A computer program comprising instructions which, when the program is executed by a computer, cause the computer to perform a method (1300), the method (1300) comprising:
maintaining (1301) a first dataset (101) indicating one or more neighboring network devices (100);
maintaining (1302) a plurality of second datasets (102) each indicating one or more user IDs, wherein one second dataset (102) of the plurality of second datasets is associated with the network device (100), and each other second dataset (102) of the plurality of second datasets is associated with one of the one or more neighboring network devices (100) in the first dataset (101);
receiving (1303) a plurality of signals (103) from a plurality of user devices (110) in a first interval (401), wherein each signal (503, 703) comprises a respective user ID of one of the user devices (110) and a respective payload of one of the user devices (110);
separating (1304), in the first interval (401), one or more signals (503) of the plurality of signals to obtain the respective user IDs and the respective payloads of the one or more signals (103); and
sending (1305), in the first interval (401), first exchange information (104) to each neighboring network device (100), which is in the first dataset (101) and is associated with a second dataset (102) that includes at least one of the obtained respective user IDs;
wherein the first exchange information (104) comprises at least one of the obtained respective user IDs and at least one of the obtained respective payloads.
